(19) United States
(12) Patent Application Publication
(10) Pub. No.: US 2007/0262946 A1
(43) Pub. Date: Nov. 15, 2007

(54) Systems and methods for controlling display device

(75) Inventors: Han-Chau Chen, Tainan Hsien (TW); Chun-Jen Lin, Tainan Hsien (TW); Mao-Jung Chang, Jhunan Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/432,169

(22) Filed: May 11, 2006

(51) Int. Cl. G09G 3/36

(52) U.S. Cl. 345/102

(57) ABSTRACT

Systems and methods of controlling display device are provided. A representative system includes a control circuit and a register. The control circuit, which is coupled to the display device, alternately enables and disables driving of the display device by referring to a first control value and a second control value to keep an image shown on the display device. The register, which is coupled to the control circuit, stores the first control value and the second control value.

### BACKGROUND OF THE INVENTION

1. Field of the Invention

The present invention relates to systems and methods for controlling a display device.

2. Description of the Prior Art

Most cellular phones on the market comprise a display device such as a liquid crystal display to show an interface through which a user can manipulate the cellular phone. When a cellular phone is powered on but not in use for a period of time, the cellular phone probably enters a stand-by mode for the sake of protecting the display device or lowering power consumption of the entire cellular phone. Two common stand-by modes are an idle mode and an eight-color mode. In addition, a cellular phone also comprises a control circuit to control the display device. However, in either an idle mode or an eight-color mode, the control circuit is required to send data to the display device to keep a stand-by image shown on the display device. In short, although a cellular phone operates in a stand-by mode, the control circuit of the cellular phone still consumes too much power.

### SUMMARY OF THE INVENTION

Systems for controlling a display device are provided. An embodiment of such a system comprises a control circuit and a register. The control circuit, which is coupled to the display device, alternately enables and disables driving of the display device by referring to a first control value and a second control value to keep an image shown on the display device. The register, which is coupled to the control circuit, stores the first control value and the second control value.

Another embodiment of such a system comprises means for alternately enabling and disabling driving of the display device by referring to a first control value and a second control value to keep an image shown on the display device; and means for storing the first control value and the second control value.

Methods for controlling a display device are provided. An embodiment of such a method comprises alternately enabling and disabling driving of the display device by referring to a first control value and a second control value to keep an image shown on the display device.

### BRIEF DESCRIPTION OF THE DRAWINGS

FIG. 1 shows a display system of an electronic device according to an embodiment of the present invention.

FIG. 2 shows the timing diagram of the power consumption of the display system 1 00 of FIG. 1.

### DETAILED DESCRIPTION

Recently, a kind of thin film transistor (TFT) LCD, which is made by a low temperature poly silicon (LTPS) technology, was introduced. Compared to a conventional amorphous TFT LCD, which has a leakage current in an order of 10⁻⁵˜10⁻⁶ A, the LTPS TFT LCD has a leakage current only in an order of 10⁻⁹˜10¹³ A. Obviously, the leakage current of the LTPS TFT LCD is much smaller than the leakage current of the amorphous TFT LCD. Due to the characteristic of low leakage current, the data, more specifically the voltage level, on each liquid crystal cell of an LTPS TFT LCD can be kept for a longer time. In other words, when each liquid crystal cell of an LCD made by LTPS TFT is fed into data, i.e., is charged to a voltage level, an image is therefore shown on the LCD. Afterwards if the liquid crystal cells are not re-flashed, i.e., if there is no more data fed into the liquid crystal cells, the same still image will not fade out until the charges on the liquid crystal cells are drained out by the little leakage current. Consequently, without re-flashing data stored on LCD cells, an LTPS TFT LCD, compared to a conventional amorphous TFT LCD, can keep the image shown on the display for a longer time.

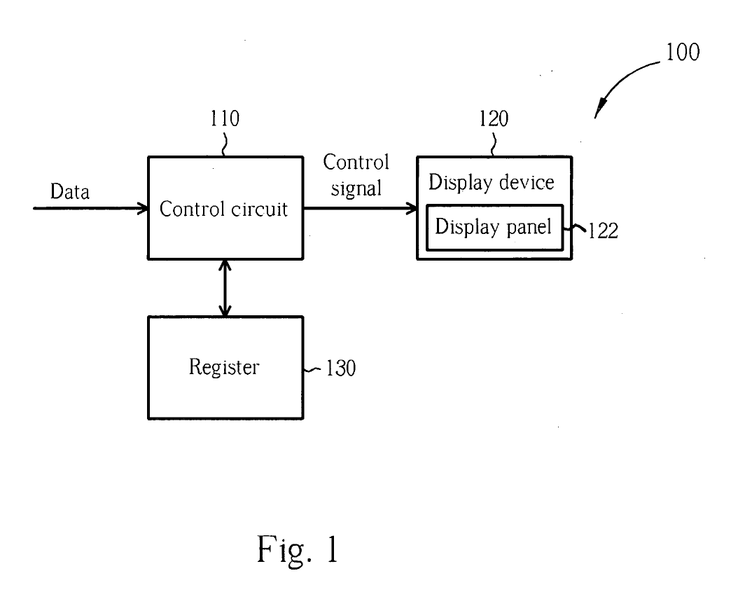

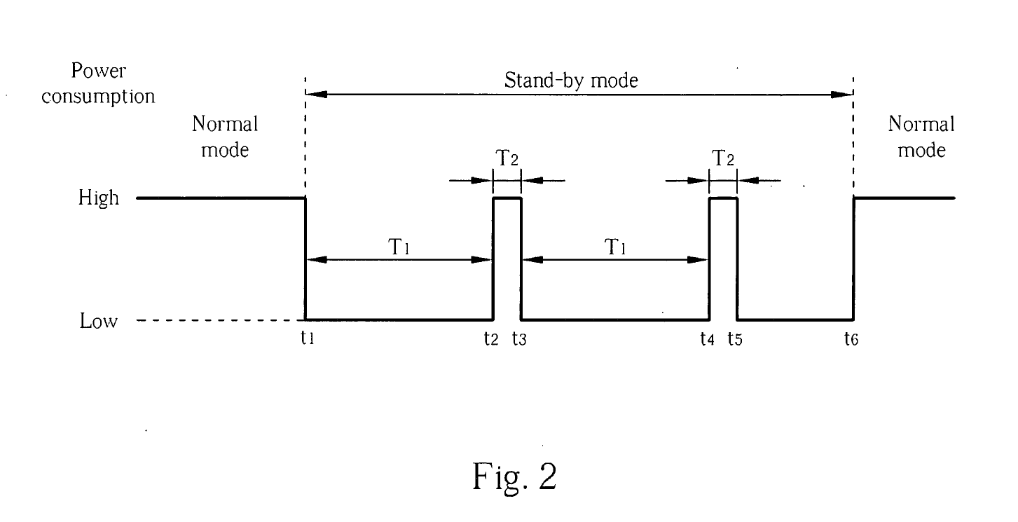

By utilizing the above-mentioned characteristic of low leakage current, any electronic device comprising a display device (e.g., a laptop computer, a mobile phone, a digital camera, a personal digital assistant (PDA), a desktop computer, a television, a car display or a portable DVD player) can save more power in a stand-by mode. With reference to FIG. 1, FIG. 1 shows a display system of an electronic device according to an embodiment of the present invention. The display system 100 comprises a control circuit 1 10, a display device 120 and a register 130. The display device 120 is utilized to display images on a display panel 122 (e.g., a liquid crystal display panel), and the control circuit 110 is in charge of controlling the display device 120. More specifically, if the display device 120 is a liquid crystal display (LCD), the control circuit 110 receives data and then sends control signals to control each pixel or each liquid crystal cell of the LCD. When the electronic device to which the display system 100 belongs enters the stand-by mode, the control circuit 110 alternatively enables and disables driving of the display device 120 by referring to control values stored in the register 130. With additional reference to FIG. 2, FIG. 2 shows the timing diagram of the power consumption of the display system 100. Before time t₁, the electronic device operates in a normal mode, and the control circuit 110 enables the controlling of the display device 120 by continuously sending control signals to the display device 120. From time t₁ to time t₆, the electronic device enters the stand-by mode. Once the electronic device enters the stand-by mode at time t₁, the control circuit 110 disables the driving of the display device 120 for a time period T₁. The time period T₁ is determined by the control value stored in the register 130. From time t₁ to time t₂, i.e., during the time period T₁ when the display device 120 is not driven by the control circuit 110, the charges stored in each LCD cell can be maintained for a period of time due to the fact that an LTPS TFT LCD has a very small leakage current. Therefore, the image shown on the display device 120 will not vanish immediately after the control circuit 110 stops driving the display device 120. Instead of suddenly vanishing, the image shown on the display device 120 fades out gradually, and before the image becomes so thin that the user has difficult in seeing the image, the control circuit 110 enables driving of the display device 120 to re-flash the image. Afterwards, from time t₂ to t₃, i.e., during the time period T₂ when the display device 120 is driven by the control circuit 110, the control circuit 110 again sends the control signal to drive the display device 120. The control signal corresponds to the data sent to the control circuit 110 immediately after the electronic device enters the stand-by mode. That is, the stand-by image is re-flashed on the display device 120. The time period T₂ is also determined by the control value stored in the register 130. During the time period T₂, the control circuit 110 re-flashes the display device 120 for several frames such that the LCD cells can be charged again and the stand-by image therefore lasts longer.

After the re-flashing process, the control circuit 110 again disables the driving of the display device 120 for the same time period T₁ from time t₃ to time t₄ for saving power. Before the electronic device turns back to the normal mode again at time t₆, the stand-by image requires being re-flashed again from time t₄ to time t₅, which also lasts for the same time period T₂.

The register 130 stores several sets of control values. Each set includes a first control value and a second control value for respectively determining the non-driving time period T₁ and the driving time period T₂. After a set of control values is determined by the user, the control circuit 110 reads the set of control values to determine the time periods T₁ and T₂. Please note that the control circuit 110 disables the driving of the display device 120 by cutting off sending control signals to the display device 120 for saving power. To save more power, the control circuit 110 disables the driving of the display device 120 by powering off the control circuit 110. As a result, during time periods T₁ when the display device 120 is not driven, even the control circuit 110 does not consume power.

In summary, an electronic device becomes more energy saving in a stand-by mode by alternatively enabling and disabling the driving of the display device belonging to the electronic device. A control circuit of the electronic device, which is in charge of controlling the display device, refers to control values stored in a register coupled to the control circuit to determine when and for how long a time to disable or enable the driving of the display device. The control circuit disables the driving of the display device by not sending control signals to the display device, or powering off for achieving even less power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for controlling a display device, comprising:
a control circuit, coupled to the display device, for alternately enabling and disabling driving of the display device by referring to a first control value and a second control value to keep an image shown on the display device; and
a register, coupled to the control circuit, for storing the first control value and the second control value.

2. The system of claim 1, further comprising a display device wherein the display device is a flat panel display device.

3. The system of claim 2, wherein the flat panel display device is an LCD comprising a liquid crystal display panel, and the control unit is operative to control the liquid crystal display panel to render the image shown thereon.

4. The system of claim 3, wherein the LCD is a low temperature poly silicon (LTPS) thin film transistor (TFT) LCD.

5. The system of claim 1, wherein the system comprises an electronic device having the display device positioned therein, and the control circuit alternately enables and disables driving of the display device when the electronic device enters a stand-by mode.

6. The system of claim 5, wherein the stand-by mode is an idle mode or an eight-color mode.

7. The system of claim 5, wherein the electronic device is a laptop computer, a mobile phone, a digital camera, a personal digital assistant (PDA), a desktop computer, a television, a car display or a portable DVD player.

8. The system of claim 1, wherein the first control value defines a first period of time for disabling driving of the display device, the second control value defines a second period of time for enabling driving of the display device.

9. The system of claim 1, wherein the control circuit is powered off or stops sending data to the display device for disabling driving of the display device.

10. The system of claim 1, wherein the register stores a plurality of control value sets each having a first control value and a second control value, and the control circuit alternately enables and disables driving of the display device by referring to one of the control value sets.

11. A system for controlling a display device, comprising:
means for alternately enabling and disabling driving of the display device by referring to a first control value and a second control value to keep an image shown on the display device; and
means for storing the first control value and the second control value.

12. A method for controlling a display device, comprising:
alternately enabling and disabling driving of the display device by referring to a first control value and a second control value to keep an image shown on the display device.

13. The method of claim 12, wherein the display device is a flat panel display device.

14. The method of claim 13, wherein the flat panel display device is an LCD comprising a liquid crystal display panel, and keeping the image shown on the display device is performed by controlling the liquid crystal display panel.

15. The method of claim 14, wherein the LCD is a low temperature poly silicon (LTPS) thin film transistor (TFT) LCD.

16. The method of claim 12, wherein the display device belongs to an electronic device, and the driving of the display device is alternately enabled and disabled when the electronic device enters a standby mode.

17. The method of claim 16, wherein the standby mode is an idle mode or an eight-color mode.

18. The method of claim 16, wherein the electronic device is a laptop computer, a mobile phone, a digital camera, a personal digital assistant (PDA), a desktop computer, a television, a car display or a portable DVD player.

19. The method of claim 12, wherein the first control value defines a first period of time for disabling driving of the display device, the second control value defines a second period of time for enabling driving of the display device.

20. The method of claim 12, wherein the display device is driven by a control circuit, and disabling driving of the display device comprises powering off the control circuit or controlling the control circuit to stop sending data to the display device.
